(19) United States
(12) Patent Application Publication
(10) Pub. No.: US 2007/0113845 A1
(43) Pub. Date: May 24, 2007

(54) Emergency hood and respirator device

(76) Inventors: Paul W. O'Brien, Tunkhannock, PA (US); William D. Reidsema, South Montrose, PA (US)

Correspondence Address: CHARLES A. WILKINSON, ESQ., 68 EAST BROAD STREET, P. O. BOX 1426, BETHLEHEM, PA, 18016-1426, US

(21) Appl. No.: 11/480,776

(22) Filed: Jul. 3, 2006

Related U.S. Application Data
(60) Provisional application No. 60/696,140, filed on Jul. 1, 2005.
(60) Provisional application No. 60/723,522, filed on Oct. 4, 2005.

(51) Int. Cl. A62B 18/08; A62B 17/04

(52) U.S. Cl. 128/201.19; 128/201.23

(57) ABSTRACT

A hood and respirator device including emergency lighting and locator features for aiding the wearer in escaping a dangerous circumstances and for enabling rescue personnel to more quickly locate the wearer, the lighting and locator features preferably being secured to the respirator device, and the respirator in addition forming the top of a sealed storage package for the device.

### CROSS-REFERENCE TO PREVIOUS RELATED APPLICATION

This invention claims priority from U.S. Provisional Patent Application Ser. No. 60/696,140, filed on Jul. 1, 2005, and U.S. Provisional Patent Application Ser. No. 60/723,522 filed on Oct. 4, 2005, the complete disclosures of which are incorporated herein by reference.

### BACKGROUND OF THE INVENTION

1. Field of the Invention

The present invention relates generally to respirator and head protection devices such as smoke, gas, and fire masks for preventing inhalation of dangerous gases and particles, and more particularly to a protective hood and respirator device having a light means for improving the wearer's ability to see in a smoke, gas, or other contaminant filled environment, as well as locator means to aid emergency personnel and the like in locating persons in such an environment.

2. Preliminary Discussion

The possibility of an individual encountering an urgent or emergency situation wherein there is a danger of being trapped in a closed area filled with air contaminated by smoke or other noxious fumes, due to an accidental fire or explosion, chemical spill, or even terrorist attack, is ever-increasing. Such an emergency could occur at home, in an apartment complex, hotel, or high-rise building, while traveling on a train, subway, bus, airplane, at work, as well as in many other ways, many of which are likely to be unexpected. There is thus a growing need for a protective hood or mask of a type which is secured over one's head that is light weight and compact so that it can be carried in a purse, backpack, duffle bag, or stored unobtrusively in a desk drawer, nightstand, or the like and thus is readily available for use, that is packaged in a simple to open, user-friendly manner so that the mask can be quickly utilized under stress, and that is inexpensive to manufacture while still providing adequate protection against inhalation of potentially deadly smoke particles or other fumes, as well as heat and fire resistant. In addition, the protective hood should include instruments to aid the user in attempting to escape the danger site, such as a light source to aid in orienting the user in a smoky environment and to light possible escape paths, and an auditory and visual emergency beacon or locator means to alert rescue personnel as to one's position, leading to quicker rescues and possible life savings. The present inventors have conceived of an improved emergency hood and respirator device incorporating these desired features, none of which features as far as the inventors are aware are known or suggesting in any combination in the prior art.

### OBJECTS OF THE INVENTION

It is therefore a primary object of the present invention to provide a combination emergency fire resistant hood and respirator device which includes emergency lighting and locator features to aid the wearer in escaping an emergency situation as well as to guide rescue personnel to the wearer's location.

It is a further object of the invention to provide a combination emergency fire resistant hood and respirator device wherein the emergency lights and locator devices are mounted in the respirator filter ring on the front of the device.

It is a still further object of the invention to provide a combination emergency fire resistant hood and respirator device including GPS locator technology.

It is a still further object of the invention to provide a combination emergency fire resistant hood and respirator device that is provided in an easy to open storage package and is inexpensive to manufacture and easy to operate.

Still other objects and advantages of the invention will become clear upon review of the following detailed description in conjunction with the appended drawings.

### SUMMARY OF THE INVENTION

A fire resistant combination hood and respirator device is provided, the device additionally including a light source for illuminating the immediate vicinity of the user, and audible and visual locator means such as a blinking light and sounding device to more quickly attract the attention of rescue personnel. The device includes a fire and heat resistant hood, a respirator device mounted to the hood, and a visor, as well as the light and locator means of the invention, which is preferably provided in the filter ring portion of the respirator. In one embodiment, the charcoal filter of the respirator is sealed in an air-tight package, with the front of the respirator forming the top of the package and including a handle which is grasped and then used to remove the device from the package for use. The light and locator means may also be provided in separate housing that is unobtrusively mounted either to the hood or respirator.

### BRIEF DESCRIPTION OF THE DRAWINGS

FIG. 1 is a perspective view from the side of the protective hood of the present invention.

FIG. 2 is an isometric view of the housing for the light source and locator means of the present invention.

FIG. 3 is a partial view of the rip cord and tab member arrangement in the present invention used to activate the lights and enunciator.

FIG. 4 is a perspective view from the front of another embodiment of the protective hood and breathing mask device of the invention wherein the light and enunciator housing is secured to the breathing filter apparatus.

FIG. 5 illustrates a possible package arrangement for the protective hook and mask device of the present invention.

FIG. 6 is a perspective view of another embodiment of the filter ring portion of present invention.

FIG. 7 is a front view of the filter ring shown in FIG. 6.

FIG. 8 is a top view of the filter ring shown in FIGS. 6-7.

FIG. 9 is a side view of the filter ring shown in FIGS. 6-8.

FIG. 10 is a perspective view of another embodiment of the emergency hood and mask device of the present invention utilizing the filter ring shown in FIGS. 6-9.

### DESCRIPTION OF THE PREFERRED EMBODIMENTS

The following detailed description is of the best mode or modes of the invention presently contemplated. Such description is not intended to be understood in a limiting sense, but to be an example of the invention presented solely for illustration thereof, and by reference to which in connection with the following description and the accompanying drawings one skilled in the art may be advised of the advantages and construction of the invention. The invention is intended to cover alternatives, modifications, and equivalents, which may be included within the spirit and scope of the invention as defined by the appended claims.

It would be useful to have a hood and/or mask or combination thereof that could be quickly placed over the head and face in the case of an accident, terrorist attack, or other event resulting in fire smoke, toxic fumes and the like to prevent the wearer from inhaling smoke, toxic gases, or other contaminants, and which mask in addition preferably would be heat resistant and fire retardant and would protect the user from immediate injury from flames or burning and toxic substances spread in the surrounding atmosphere as a result thereof or through some other agency. Such a device would give the wearer at least some additional time to try to escape from the danger zone or to enable emergency rescue personnel to reach such person before serious or irreversible injury results. While the present inventors are aware of at least one version of this type of device, such device is not without its inadequacies and deficiencies. For example, once the hood has been placed over the user's head, it will presumably be more difficult than usual for the user to see, not only due to the mask itself, but also of course due to any smoke or gases in the air that caused the user to don or put the hood on in the first place. Such smoke and gases can quickly turn a bright or sunlit room or other area dark, and in addition often in an emergency situation any lighting or electrical power in a building is automatically shut off, and only dim emergency lighting is available. Therefore, the present inventors have conceived that it would be useful to provide a light source such as a small LED light on such mask that would be aimed forwardly to aid the wearer in trying to escape injury from smoke, gases, flames, or the like. In addition, emergency personnel who are trying to locate and assist victims in the immediate danger zone also frequently have a very difficult time seeing, and therefore the present inventors also have realized that it would be extremely useful and in many instances crucial to have a locator means connected to the emergency mask, which locator means may include an emergency light locator, an enunciator or sonic locator, or both.

FIGS. 1-3 illustrate a first embodiment of the protective device 10 of the present invention. Protective device 10 is comprised of a flexible hood 12 which is placed over and covers the user's head, a heat-resistant transparent face shield 14 situated adjacent the eye area of hood 12, a filtering-type respirator 16 connected to hood 12 by rivets or any other suitable means adjacent the nose and mouth area of the wearer, just below face shield 14, and housing 22 secured to and along the top front area of hood 12, the purpose of which is described in further detail below. Hood 12 is made from a heat reflective and fire retardant fabric or material, or a thin coating of such material, and preferably is sized to cover the entire head, neck and upper shoulder area of the wearer. Replaceable filter element 18 is connected to respirator 16, while strap 20 is used to secure hood 12 over the user's head and the user's mouth tightly against respirator 16 to prevent noxious fumes from seeping into the breathing device through the neck opening.

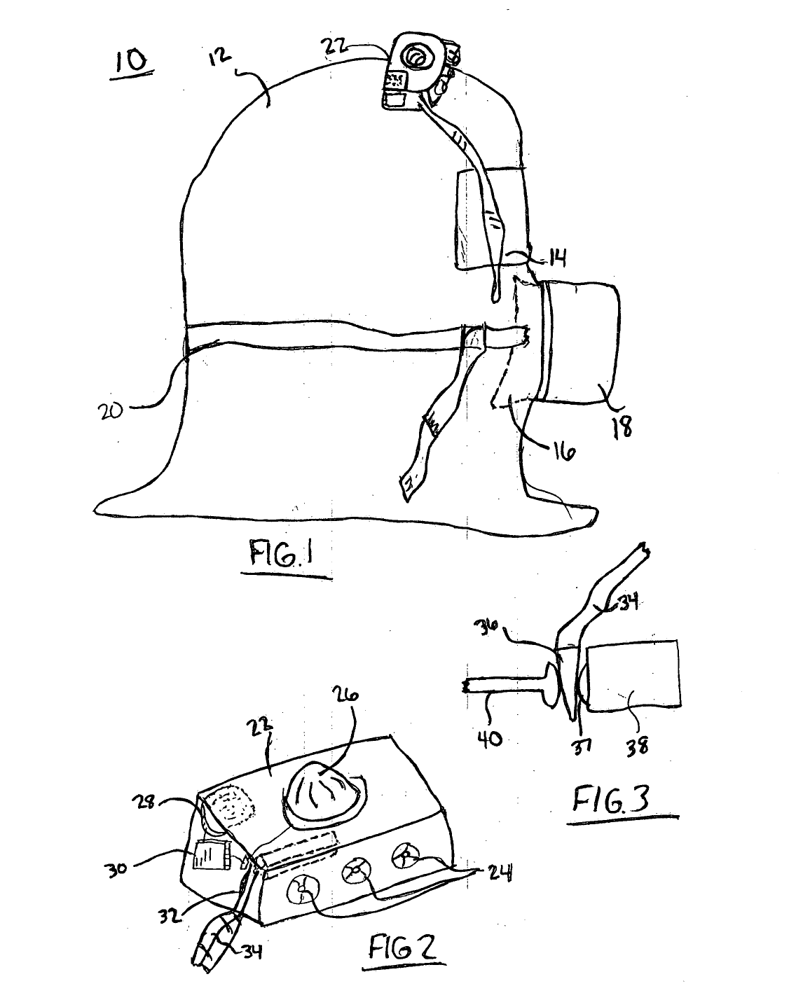

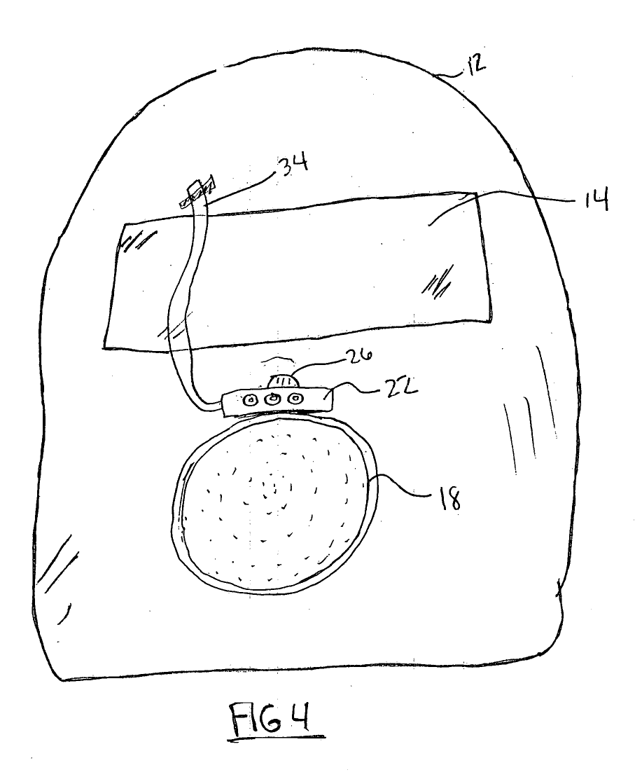

Referring now to FIG. 2, there is shown housing 22 in which housing the light source and locator means, both visual and auditory, of the invention are arranged. Light source 24 is preferably comprised of one or more battery-powered LED lights arranged in a row along front panel 23 of housing 22, so that when breathing device 12 is in use, the beams of light eminating from light source 24 are directed forwardly. In addition, battery-powered signal light 26 is mounted along the top surface 25 of housing 22. Signal light 26 may be colored and preferably is a blinking light so as to hopefully more quickly attract the attention of emergency personnel or the like of the vicinity of the person donning or wearing protective device 10. Both lights 24 and 26 are preferably LED lights, although any other suitable bulbs or chemically generated light sources may also be used. Also in housing 22 is an enunciator 27 which may be comprised of a speaker 28 connected to a sounding device 30, and which is also battery powered. Any known preferably intermittent sounding device may be used, with the purpose of the enunciator also of course being to hopefully inform emergency personnel of one's exact location more quickly, thereby improving the chance of a successful rescue. In addition, extending outwardly from slot 32 in housing 22 is a rip cord arrangement 34, which is used to quickly activate lights 24 and 26 and enunciator 25. As shown in FIG. 3, the forward end of rip cord 34 is provided with a non-conductive tab member 36 that is wedged between electrical contact 37 of battery 38 and contact 40 which is electrically connected to LED lights 24, signal light 26, and sounding device 30. Thus, upon deployment of mask 10, which is preferably but not necessarily a single-use type mask, rip cord 34 will be hanging downwardly from housing 22, preferably with the end of cord 34 secured by a small piece of tape or adhesive hanging over face shield 14 so that it is readily visible to the wearer of mask 10. In practice, after protective device 10 is placed over the user's head and strap 20 tightened, when rip cord 34 is pulled, tab member 37 will be pulled out from between battery contact 37 and contact 40, which contacts will then touch, completing an electrical circuit and activating LED lights 24, signal light 26, and the sounding device 30. Housing 22 is preferably mounted on hood 12 by rivets or the like extending through the hood material, or by another suitable means. A frame member such as a plastic ring may be provided in the top of or attached to the top of hood 12 or otherwise in combination with housing 22 to assist in maintaining housing 22 oriented with the beam from LED lights 24 pointed generally forwardly and slightly downwardly so as to maximize their effectiveness in enhancing visual positioning of the wearer's light and therefore both the users visibility and the light visual field. Lights 24 may also swivel if desired. An on/off switch may also be provided in place of rip cord 34; however, it is believed that particularly in an emergency situation, which is likely to be stressful, use of rip cord 34 reduces the chances that the wearer, in a panic, forgets or is not able to activate the lights and enunciator, or that they may accidentally become deactivated prior to reaching safety.

In another possible embodiment, instead of mounting housing 22 on the top front portion of hood 12 as shown and described above with reference to FIGS. 1-3, the housing could be mounted on filter device 18 extending outwardly from face mask 16 along the front of the mask. Such an arrangement is generally illustrated in FIG. 4. A fire resistant adhesive, band, strap, or other means may be used to secure housing 22 to the outer periphery of filtering device 18. As in the previous embodiment, the free end of rip cord 34 may be secured by a piece of tape or the like so that it extends across face shield 14 and therefore will be evident to the wearer through such face shield and thus remind the wearer to pull the cord. In this embodiment, housing 22 may be alternatively arranged so that the blinking signal light 26 is situated on a side face or panel of housing 22, or in some other manner so that it is not blinking directly in the wearer's eyes. In another embodiment, not shown, two separate housings may be provided, one mounted on the filtering device for lights 24, and another mounted on the top of hood 12 as in FIGS. 1-3 for holding the signal light and enunciator. This may be a particularly efficient arrangement from an efficiency standpoint as it places both units in a very effective location. However, the provision of a single housing for such lights and enunciator may be a more cost-effective and practical arrangement for use with the invention.

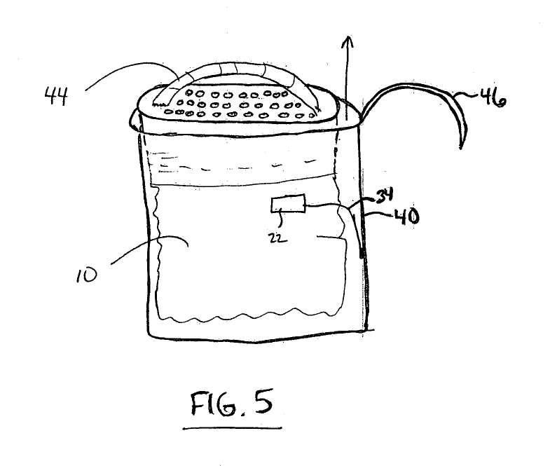

Due to the nature of the charcoal filtering device, either the entire mask 10 or at least the filtering device should be enclosed in an airtight seal or package up until the time of actual use of the mask and hood. In another possible embodiment, shown in FIG. 5, the device 10 is arranged in a package 40 so that the front surface 42 of the filtering device 20 is facing upwardly, with hood 12 folded and compressed in the package underneath the filtering device. In addition, there is a handle 44 provided attached to front surface 42 for quickly grasping and pulling the device 10 out of the package 40. An airtight peel-off seal member 46 may be provided over the mouth of package 40, preferably having a tab portion 48 to facilitate easy removal of the seal member. After the emergency hood and mask device has been removed from package 40, the user may continue to hold handle 44 as the hood is unfolded and then quickly place it over his or her head. In addition, the loose end of rip cord 34 may be secured on one end to the inner surface of package 40, so that when the device is removed from package 40, the rip cord is pulled and the tab member (shown in FIG. 3) is removed from between the battery and light/sound contacts and the LED lights, signal light, and enunciator are all immediately activated. While it is generally preferred for the frame section 51 to be molded integral with the sleeve section 52, the ring section containing the emergency communicators or attention attracting features could also be otherwise secured thereto such as having inner threads on the ring section screw engageable with matching outer threads on the sleeve section.

In a variation of the foregoing canister sealing arrangement, the rear of the canister may also be sealed with a long lasting plastic film which is attached on one side to the end of a rip cord arrangement leading along the side of the canister through the hood such that when the rip cord is pulled the plastic film over the rear of the canister is pulled off and pulled into the passage, effectively sealing the passage, and exposing both ends of the canister to the atmosphere, since the rip cord will also be attached to a plastic film seal over the front of the canister as well. This effectively eliminates the necessity of maintaining the hood and canister in a sealed package until use and makes it much easier to don or put on and activate the emergency hood and respirator apparatus. It also enables a potential user to practice putting on the hood without actually activating the canister. Such preliminary practice is a substantial consideration in both effective use of the hood and in an emergency situation and in enabling potential customers or users to try the hood before purchase or use.

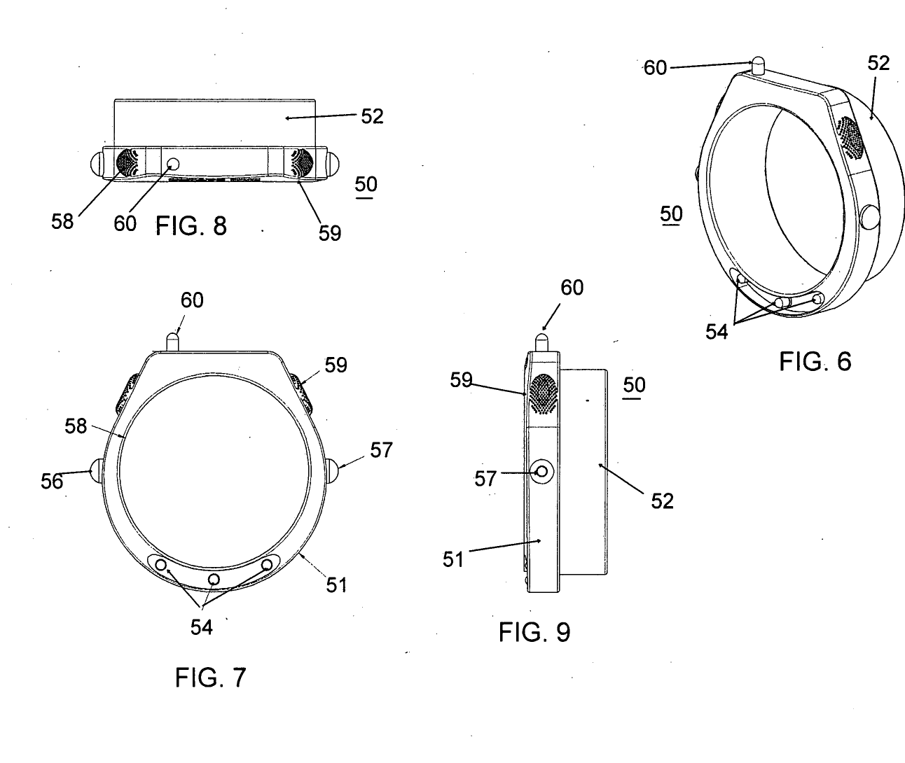

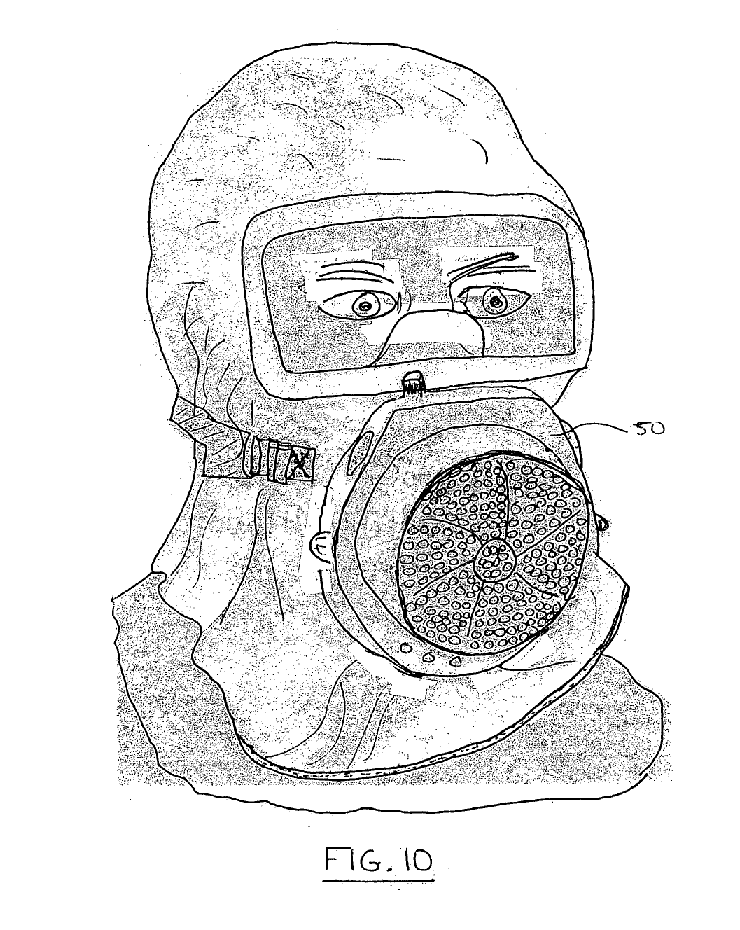

FIGS. 6-9 are perspective, front, top and side views of another embodiment of the ring 50 used for holding the filter element of fire and smoke mask 10 to such mask. Ring 50 is preferably made of high temperature resistant plastic, although other materials could be used, and is comprised generally of a frame section 51 and a sleeve section 52 extending rearwardly from frame section 51. Ring 50 may be permanently secured to hood 12 in several ways, such as by rivets, adhesive bonding, press fitting or clamping, or other suitable means. In the illustrated embodiment, the LED light and location aid devices of the invention are mounted in frame section 51, rather than in a separate housing such as that already described which is then mounted to the hood or on the filtering device. More particularly, mounted on the lower periphery of the front surface 53 of frame section 51 are several LED lights 54 which when the mask 10 is in use will be turned on, preferably automatically, and, as indicated above, will illuminate an area immediately adjacent the wearer of mask 10, which hopefully will aid the wearer to more quickly find an escape route, particularly in a smoke-filled room or interior area. While three LED lights mounted on front surface 53 of frame section 51 are shown in FIGS. 6-9, a greater or lesser number of lights may be utilized. In addition, while in FIGS. 6-9 the LED lights are positioned so that the light beams are directed generally in the direction the wearer's face is looking, additional beams may be facing in other directions, such as downwardly, or alternatively the direction of the light beams may be adjustable or include both narrow and wide beams as is desired to best illuminate the surroundings of the wearer.

In addition, located pointing outwardly generally from the sides of frame section 51 of ring 50 are blinking or flashing lights 56 and 57. Rather than being designed to illuminate a portion of the immediate surroundings, as is the case with LED lights 54, lights 56 and 57 will emit flashes of light designed to attract the attention of emergency personnel and the like as to the wearer's location in the event of an emergency situation. Also provided on frame section 51 above lights 56 and 57 are speakers 58 and 59, which will be connected to a sounding device and will emit a loud sound when activated. As indicated above, the loud sound is also designed to aid emergency personnel and the like in finding or locating the wearer of the mask. Finally, provided on the top surface of frame section 51 is control button 60. Button 60 in one embodiment is electronically connected in a manner evident to those skilled in the art to speakers 58 and 59 and their associated sounding device, and may be used to turn such sounding devices off or on as is desired by the wearer. Button 60 may also be a multifunction type button, wherein it may be electronically connected in parallel to LED lights 54, flashing lights 56 and 67, and speakers 58 and 59, and, depending upon the number of times such button is pressed, may be used to control each of such devices individually or as a group. For example, the button may be arranged so that when it is pressed one time, the sounding device associated with speakers 58 and 59 is turned off, and when the button is pressed twice flashing lights 56 and 57 may be turned off. The button may also be similarly arranged to turn one or all of such devices on either altogether or individually. It is still preferred, however, as described with respect to the embodiment shown in FIGS. 4 and 5 above, that all of the devices associated with such mask be turned on immediately and automatically upon deployment of the mask, such as by use of a ripcord.

FIG. 10 illustrates an emergency hook and mask of the present invention using the filter ring 50 shown and described with reference to FIGS. 6-9 for holding the respirator or filtering device. In practice, after the emergency hood and mask device is removed from its packaging, and the hood pulled down over the user's head with the visor and breathing filter apparatus positioned in front of the eyes and mouth of the wearer, respectively. Then, control button 60 is pressed one or several times depending upon the desired mode of operation of the emergency lights and enunciator electrically connected to such control button in filter ring 50. The protective device will then be worn until the wearer has escaped the emergency area.

In addition to the devices shown and discussed above, the present inventors have also contemplated that the mask 10 be provided with a Global Positioning System (GPS) receiver. GPS is, of course, a well known system wherein a plurality of satellites are use to triangulate, or take measurements, to determine the location of a receiver with surprisingly high precision or accuracy. In an emergency situation, such as, for example, an accident or fire in a subway or large building, the location of accident victims or persons trapped could be more precisely determined. In one embodiment, the GPS receiver will replace one of the speakers 58 or 59, while in another embodiment a separate housing on the surface of frame section 51 will be provided. In still another embodiment, the GPS receiver may be positioned at a different location on mask 10, such as on the head area of such mask. Preferably, however, regardless of its position, the GPS receiver should also be automatically activated as soon as the mask is deployed from its packaging or the like for use.

While the present invention has been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the invention

We claim:

1. An emergency fire resistant hood and respirator arrangement having therewith an emergency lighting and locator package comprising:
a. a lighting arrangement for aiding the orientation of the user in the surroundings by illuminating at least a portion of the surroundings.
b. a locator device to aid rescue personnel to find the wearer of equipment.

2. An emergency fire resistant hood and emergency lighting and locator package in accordance with claim 1 wherein the locator device comprises a flooding light.

3. An emergency fire resistant hood and emergency lighting and locator package in accordance with claim 1 wherein the locator device is a regularly varying sound device.

4. An emergency fire resistant hood and emergency lighting and locator package in accordance with claim 1 wherein the locator device comprises both light and sound producing means.

5. An emergency fire resistant hood and respirator package wherein the respirator comprises the top of a protective package and is sealed on the front with a plastic sealing film removable with a grasping means attached to the canister.

6. An emergency fire resistant hood and respirator package in accordance with claim 5 wherein the rear of the canister is also sealed with a plastic film attached through an extension passing through the hood adjacent the canister for removing the rear plastic film.

7. An emergency fire resistant hood and respirator package in accordance with claim 6 additionally comprising an emergency light and locator means secured to the hood and operable by the grasping means.

8. An emergency fire resistant hood and respirator package in accordance with claim 7 wherein the grasping means comprises a ripcord arrangement.

9. An emergency fire resistant hood and respirator package in accordance with claim 7 wherein the locator means comprises a Global Positioning System (GPS) receiver.

10. An emergency fire resistant hood and respirator package in accordance with claim 1 wherein said lighting and locator devices are integrally connected to the frame portion of said respirator.

11. An emergency fire resistant hood and respirator package in accordance with claim 10 additionally comprising a means for manually controlling activation or deactivation of at least one of said lighting and locator devices.

12. An emergency fire resistant hood and respirator package in accordance with claim 11 wherein said means for manually controlling activation or deactivation of at least one of said lighting and locator devices is a multifunction button electronically connected to said device or devices.

13. An emergency fire resistant hood and respirator package in accordance with claim 12 wherein said lighting and locator devices include three LED lights, a pair of flashing lights, a pair of speakers, and a control button.

14. An emergency fire resistant hood and respirator package in accordance with claim 13 additionally comprising a GPS receiver.
